(19) United States
(12) Patent Application Publication
(10) Pub. No.: US 2012/0183331 A1
(43) Pub. Date: Jul. 19, 2012

(54) TRANSMISSION DEVICE FOR PHOTO CONDUCTOR DRUM

(76) Inventors: Shih-Chieh HUANG, Taichung County (TW); Shih-Hsiung Huang, Taichung County (TW)

(21) Appl. No.: 13/008,383

(22) Filed: Jan. 18, 2011

(51) Int. Cl. G03G 15/00

(52) U.S. Cl. 399/167

(57) ABSTRACT

A transmission device for a photo conductor drum includes a shell, a limiting apparatus mounted in the shell and having a through hole, and a transmission shaft which is coaxial with the through hole at a beginning position. When the transmission shaft is moved axially by an external force to a pressed position, the transmission shaft is inclinable relative to the through hole, and when the external force is released, an elastic member will force the transmission shaft to move back to the beginning position. As a result, while the photo conductor drum is put into a housing of a printer, the transmission shaft can connect a driving shaft without a help of a guider for enabling the photo conductor drum to rotate steady and smoothly.

### BACKGROUND OF THE INVENTION

1. Field of the Invention

The present invention relates generally to photo conductor drums installed in printers and more particularly, to a transmission device for a photo conductor drum.

2. Description of the Related Art

A photo conductor drum, which is one of the most important components of a printer, is installed in a toner cartridge to conduct electricity when photosensitized and attract carbon powders at the same time to develop the to-be-printed document. A photo conductor drum comprises a photosensitive cylinder and a transmission device attached to one end of the photosensitive cylinder. The transmission device is used to connect with a driving shaft in a housing of a printer to transmit rotatory kinetic energy from the driving shaft to the photosensitive cylinder.

A conventional transmission device for a photo conductor drum comprises a shell to be fixed to a photosensitive cylinder of the photo conductor drum, and a transmission shaft which is connected to the shell by means of a universal joint. When the photo conductor drum is installed in a toner cartridge, the transmission shaft extends out of the toner cartridge to connect with a driving shaft when the toner cartridge is mounted in a housing of a printer. Besides, the universal joint makes the transmission shaft not only coaxial with the photosensitive cylinder when the transmission shaft connects with the driving shaft but also inclinable to any direction relative to the photosensitive cylinder. As a result, when a user puts the toner cartridge into the housing of the printer so as to make the transmission shaft and the driving shaft connect with each other, the transmission shaft will first incline to a proper position and then engage with the driving shaft coaxially. On the other hand, when the user takes the toner cartridge out of the housing of the printer so as to make the transmission shaft and the driving shaft disconnect from each other, the transmission shaft will first incline to a proper position and then separate from the driving shaft.

In the aforesaid conventional transmission device for the photo conductor drum, the transmission shaft may incline to any direction when receiving no external force thereon. So, there is a guider provided inside the housing of the printer to make the transmission shaft incline to the proper position for enabling the transmission shaft to be engaged with the driving shaft. However, providing the guider inside the housing of the printer makes the inside structure of the printer's housing complicated and uneasily assembled.

### SUMMARY OF THE INVENTION

The present invention has been accomplished in view of the above-noted circumstances. It is an objective of the present invention to provide a transmission device for a photo conductor drum, which can connect with a driving shaft providing rotatory kinetic energy without a help of a guider for enabling the photo conductor drum to rotate steady and smoothly.

To attain the above objective of the present invention, the transmission device for a photo conductor drum comprises a shell, a limiting apparatus, a joint, a transmission shaft, and an elastic member. The shell has a bottom and an opening opposite to the bottom. The limiting apparatus has a connector, which is mounted in the shell and provided with a first end surface, a second end surface, and a through hole which has a first opening located at the first end surface, and a second opening located at the second end surface and closer to the bottom of the shell than the first opening, a plurality of limiters, which are mounted to the connector and swingable relative to the connector between a restriction position and a release position, and a fixed member, which is mounted to the first end surface of the connector to prohibit the limiters from swinging toward the first opening of the through hole from the restriction position. The joint is provided with an opening. The transmission shaft is mounted in the through hole of the connector, axially moveable between a beginning position and a pressed position, and provided with a first end portion which extends out of the first opening of the through hole and the opening of the shell, and a second end portion which is located in the through hole and inserted in the hole of the joint which is closer to the second opening of the through hole than the limiters. When the transmission shaft is rested at the beginning position, the joint pushes the limiters toward the first opening of the through hole such that the limiters are forced to be located at the restriction position to restrict the transmission shaft to be substantially coaxial with the through hole. When the transmission shaft is forced to the pressed position, the limiters are swingable to the release position for allowing the transmission shaft to be inclinable relative to the through hole. The elastic member is attached between the bottom of the shell and the joint to support the transmission shaft at the beginning position.

A photo conductor drum can be assembled by fastening the shell of the transmission device to one end of a photosensitive cylinder. During the process of putting the photo conductor drum into a printer, the first end portion of the transmission shaft and a driving shaft of the printer will firstly contact with each other in a manner that their axes are parallel to each other, and meanwhile, the driving shaft will force the transmission shaft to move to the pressed position; then, the transmission shaft, which continuously moves along with the motion of the photo conductor drum, will move relative to the driving shaft until the transmission shaft and the driving shaft are coaxial, and meanwhile, the transmission shaft will return to the beginning position due to the elastic member to engage with the driving shaft. On the other hand, during the process of taking the photo conductor drum out of the printer, the transmission shaft will move to the pressed position first, incline relative to the through hole of the connector at the same time, and then separate from the driving shaft. Therefore, the transmission shaft can be engaged with the driving shaft inside the housing of the printer without a help of a guider mounted inside the housing for enabling the photo conductor drum to rotate steady and smoothly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded perspective view of a transmission device for a photo conductor drum according to a preferred embodiment of the present invention;

FIG. 2 is an assembled perspective view of the transmission device for a photo conductor drum according to the preferred embodiment of the present invention;

FIG. 3 is a side view of the transmission device for a photo conductor drum according to the preferred embodiment of the present invention;

FIG. 4 is a sectional view taken along line 4-4 of FIG. 3;

FIG. 5 is a side view of a shell of the transmission device for a photo conductor drum according to the preferred embodiment of the present invention;

FIGS. 6-8 are schematic views illustrating the process of how a transmission shaft of the transmission device is engaged with a driving shaft inside a printer; and

FIGS. 9-10 are schematic views illustrating the process of how the transmission shaft of the transmission device is separated from the driving shaft.

### DETAILED DESCRIPTION OF THE INVENTION

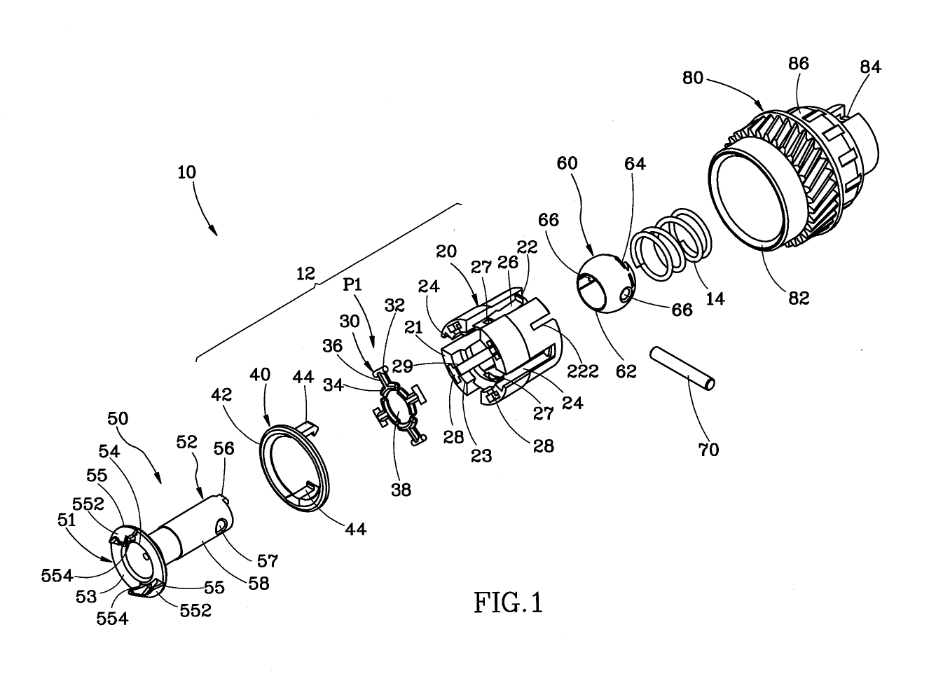

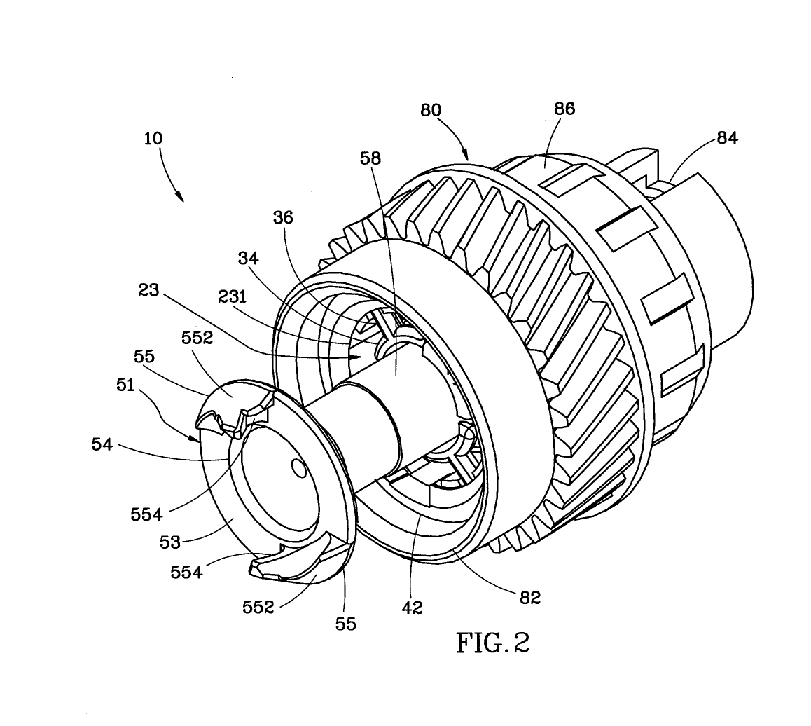

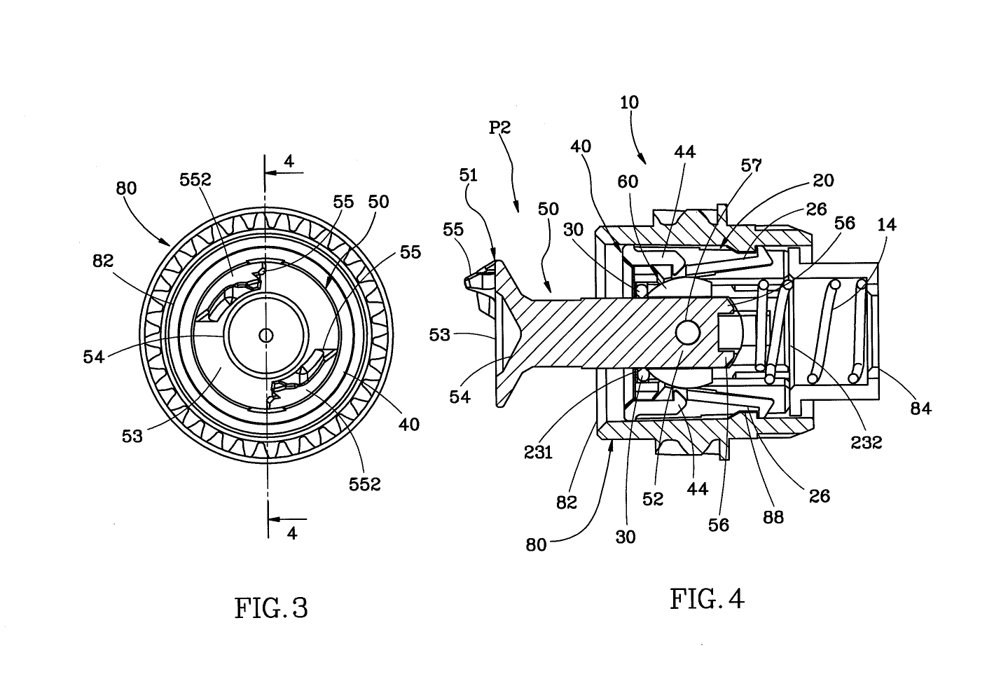

As shown in FIGS. 1-4, a transmission device, denoted by reference numeral 10, in accordance with the preferred embodiment of the present invention is a component of a photo conductor drum. The transmission device 10 includes a limiting apparatus 12 composed of a connector 20, four limiters 30 and a fixed member 40, a transmission shaft 50, a joint 60, a pin 70, a shell 80, and an elastic member 14.

The connector 20 is substantially a cylindrical tube, having a first end surface 21, a second end surface 22 opposite to the first end surface 21, and a through hole 23 penetrating through the first end surface 21 and the second end surface 22. The first end surface 21 has four gaps and is divided into four areas by those gaps. Two opposite gaps of those gaps extend a certain distance toward the second end surface 22 and form two retaining slots 24 respectively. The other two opposite gaps extend toward the second end surface 22 and form two slots, in each of which a hook 26 and a hook hole 27 are provided. Each of those areas of the first end surface 21 has a mounting groove 28 with a smaller depth and a slot 29 with a larger depth, and the slot 29 is abutted with the groove 28 and opened to the through hole 23. The connector 20 further has four locating slots 222 extending from the second end surface 22 toward the first end surface 21, and the positions of the locating slots 222 correspond to the slots 29 respectively. The through hole 23 has a first opening 231 located at the first end surface 21 and a second opening 232 located at the second end surface 22.

Each limiter 30 has a shape substantially like letter “I”, having a straight mounting portion 32, an arc limiting portion 34, and a connecting bar 36 connected between the mounting portion 32 and the limiting portion 34. The mounting portions 32 of the limiters 30 are mounted in the mounting grooves 28 of the connector 20 respectively, and the limiting portions 34 of the limiters 30 are suspended in the through hole 23 of the connector 20 and define a restraint boundary 38 thereamong. The connecting bars 36 of the limiters 30 can swing in the slots 29 of the connector 20 respectively to lower and lift the limiting portions 34 so as to enlarge or reduce the size of the restraint boundary 38.

The fixed member 40 has a ring 42 and two hooks 44 perpendicularly extending from the ring 42. The hooks 44 are engaged with the hook holes 27 of the connector 20 respectively, and the ring 42 is attached to the first end surface 21 of the connector 20 to cover the mounting grooves 28 so that the mounting portions 32 of the limiters 30 are limited in the mounting grooves 28, and the connecting bars 36 can't swing over the first opening 231 of the through hole 23. In other words, each limiter 30 can swing from a restriction position P1 where the connecting bar 36 of said limiter 30 is perpendicular to the axis of the through hole 23 toward the second opening 232 of the through hole 23. It will be appreciated that the fixed member 40 and the connector 20 can be made integrally, and in that case the limiters 30 are made from elastic materials so that the mounting portions 32 of the limiters 30 can be installed into the mounting grooves 28 through the slots 29. In other words, the fixed member 40 can be replaced by other elements which can cover the mounting grooves 28 and stop the limiters 30 from swinging toward the first opening 231 of the through hole 23 from the restriction position P1, and those elements are intended to be included within the scope of the invention.

The transmission shaft 50 has a first end portion 51 and a second end portion 52. The first end portion 51 has an end surface 53, a hollow 54 recessed inwardly from the end surface 53, and two guiding blocks 55 protruding from the end surface 53. Each guiding block 55 has a guiding surface 552 extending from an outside of the first end portion 51, and an engagement concave 554 at one side of the guiding surface 552. The second end portion 52 has two engagement blocks 56 extending longitudinally and an aperture 57 radially penetrating the transmission shaft 50, and the second end portion 52 is mounted in the through hole 23. The transmission shaft 50 has a body portion 58 which connects the first end portion 51 and the second end portion 52 and passes through the restraint boundary 38.

The joint 60 is shaped like a hollow sphere, but having an opening 62, two engagement holes 64 opposite to the opening 62, and two opposite apertures 66 perpendicular to the opening 62. The joint 60 is mounted in the through hole 23 in such a way that the opening 62 is inserted with the second end portion 52 of the transmission shaft 50 and the engagement holes 64 are engaged with the engagement blocks 56 of the transmission shaft 50. Therefore, the joint 60 is closer to the second opening 232 of the through hole 23 than the limiters 30 and is fastened to the transmission shaft 50 with the apertures 66 in alignment with the aperture 57 of the transmission shaft 50.

The pin 70 is inserted through the aperture 57 of the transmission shaft 50 and the apertures 66 of the joint 60, and two end portions of the pin 70 extend out of the apertures 66 respectively and are inserted in the retaining slots 24 of the connector 20 respectively. The widths of the retaining slots 24 limit the rotation of the transmission shaft 50 to a very small angular distance so that the transmission shaft 50 can rotate with the connector 20. By means of the engagement of the two end portions of the pin 70 with the retaining slots 24 of the connector 20, the transmission shaft 50 is axially moveable relative to the connector 20 along the longitudinal direction of the slots 24.

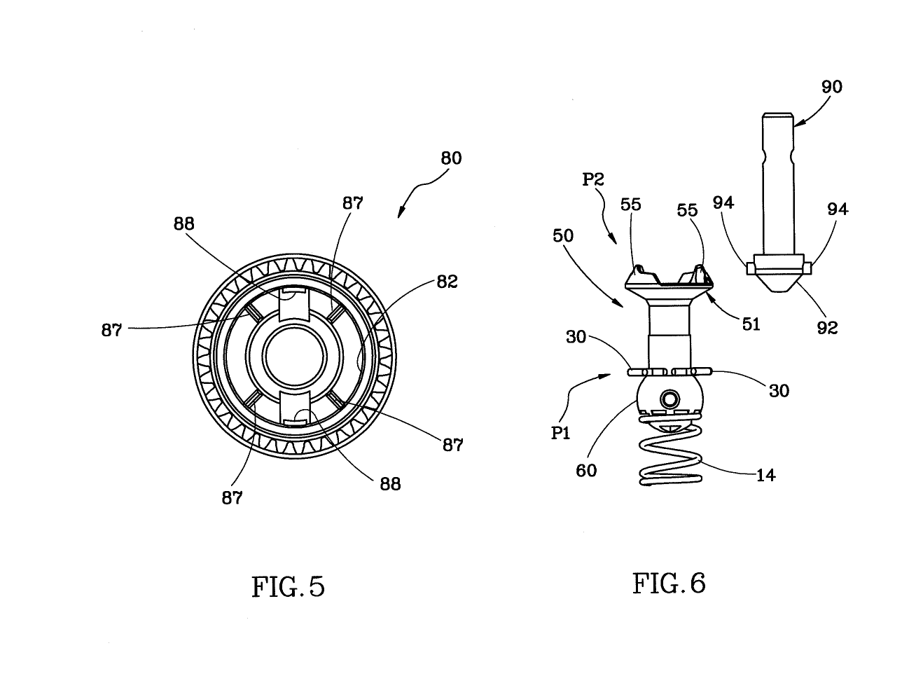

The shell 80 has an opening 82, a bottom 84 opposite to the opening 82, and a fastening portion 86 which is close to the bottom 84 and has many rectangular indentations on the periphery surface thereof. Besides, as shown in FIG. 5, the shell 80 has four ribs 87 and two blocks 88 suspended therein. Two opposite ribs 87 of those each have a smaller angular distance and a larger angular distance to the other two ribs 87 respectively, and the blocks 88 are located within said smaller angular distances respectively.

The elastic member 14 is a compression spring and mounted in the shell 80 in which the limiting apparatus 12, the transmission shaft 50, the joint 60, and the pin 70 are assembled together. The locating slots 222 of the connector 20 are engaged with the ribs 87 of the shell 80 respectively to make the hooks 26 engage with the blocks 88 so that the connector 20 and the shell 80 are bonded to each other and the two ends of the elastic member 14 are respectively stopped at the bottom 84 of the shell 80 and the joint 60. As a result, the transmission shaft 50, the joint 60, and the pin 70 can displace linearly relative to the shell 80 while the elastic member 14 is compressed or extends, and the first end portion 51 of the transmission shaft 50 extends out of the first opening 231 of the through hole 23 and the opening 82 of the shell 80.

When aforesaid transmission device 10 receives no external force thereon, the elastic member 14 pushes the joint 60 to push the limiters 30 toward the first opening 231 of the through hole 23 so that the transmission shaft 50 will be forced to stay at a beginning position P2 which is the farthest position of the transmission shaft 50 away from the bottom 84 of the shell 80. Meanwhile, the limiters 30 will be forced to stay at the restriction position P1 and their limiting portions 34 form the smallest restraint boundary 38 which is almost as small as the size of cross-sectional area of the body portion 58 of the transmission shaft 50. Therefore, the limiters 30 restrain the transmission shaft 50 to be almost coaxial with the through hole 23 of the connector 20, which means that the axes of the transmission shaft 50 and the through hole 23 are substantially in alignment with each other. At this time, if the transmission shaft 50 receives an external transverse force which acts along its radial direction, the transmission shaft 50 almost can't incline.

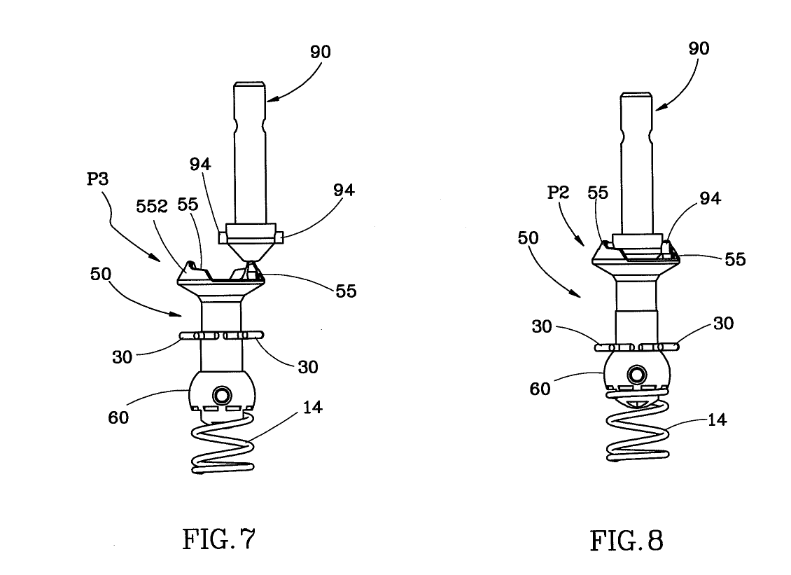

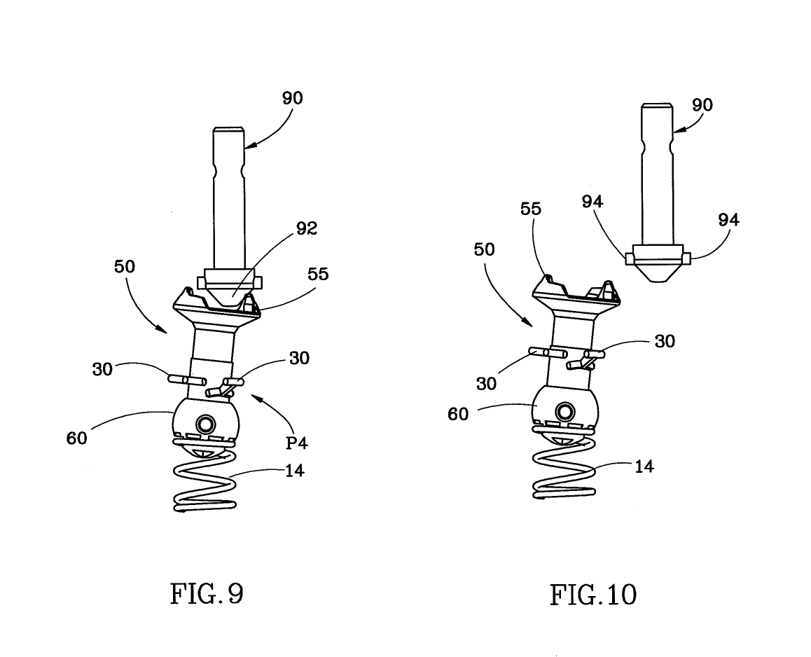

When the transmission shaft 50 receives an external axial force which acts parallel to the through hole 23 toward its second opening 232, the transmission shaft 50 will move toward the second opening 232 to a pressed position P3 as shown in FIG. 7 and push the joint 60 backward to compress the elastic member 14 at the same time. At this time, the limiters 30 are not pushed by the joint 60, so the limiters 30 can swing toward the bottom 84 of the shell 80 to a release position P4 as shown in FIG. 9. Meanwhile, if the transmission shaft 50 receives an external transverse force, the transmission shaft 50 can incline relative to the through hole 23. If the external axial force acting on the transmission shaft 50 is released, the elastic member 14 will provide an elastic returning force to make the transmission shaft 50 move back to the beginning position P2.

When aforesaid transmission device 10 according to the preferred embodiment of the present invention is used, the fastening portion 86 of the shell 80 is mounted to one end of a photosensitive cylinder (not shown) to compose a photo conductor drum. The photo conductor drum is used to be mounted in a toner cartridge (not shown) in a way that the first end portion 51 of the transmission shaft 50 extends out of one end of the toner cartridge.

When the aforesaid toner cartridge is installed in a housing of a printer (not shown), the transmission shaft 50 is engaged with a driving shaft 90 as shown in FIGS. 6-8, which is mounted inside the housing of the printer. Before being contacted with the driving shaft 90, the transmission shaft 50 is stayed at the beginning position P2 with its axis parallel to the axis of the driving shaft 90. While the toner cartridge is slidably inserted into the housing of the printer in the process of installation, the transmission device 10 will move toward the driving shaft 90 along a direction perpendicular to the axis of the driving shaft 90. Then, when the first end portion 51 of the transmission shaft 50 touches the driving shaft 90, the driving shaft 90 may relatively slide over the end surface 53 without contacting with the guiding blocks 55, or, as shown in FIG. 7, an inclined plane 92 of the driving shaft 90 may relatively slide over the guiding surface 552 of one of the guiding blocks 55. No matter whichever of aforesaid situations happens, the transmission shaft 50 will be pushed by an external axial force to move toward the bottom 84 of the shell 80 to the pressed position P3 and compress the elastic member 14 at the same time. Meanwhile, the transmission shaft 50 is abutted against a protrusion (not shown) on the toner cartridge, which is well known in related art so not necessary to be recited specifically here, so that the transmission shaft 50 is prohibited from inclining relative to the through hole 23.

When the toner cartridge keeps moving to a position where the transmission shaft 50 and the driving shaft 90 are coaxial, as shown in FIG. 8, the driving shaft 90 will insert into the hollow 54, and the elastic returning force acted by the elastic member 14 will immediately make the transmission shaft 50 move back to the beginning position P2. Thereafter, when the driving shaft 90 rotates, its two engagement bars 94 will be engaged with the engagement concaves 554 of the guiding blocks 55 respectively so that the transmission device 10 and the photosensitive cylinder can rotate with the driving shaft 90 simultaneously.

While the user takes the toner cartridge out of the housing of the printer, the driving shaft 90 may relatively slide over the end surface 53 without contacting with the guiding blocks 55 of the transmission shaft 50, or, as shown in FIG. 9, the inclined plane 92 of the driving shaft 90 may be in contact with one of the guiding blocks 55. No matter whichever of aforesaid situations happens, the transmission shaft 50 will be pushed by the driving shaft 90 to move toward the bottom 84 of the shell 80 to stop the joint 60 from pushing the limiters 30 so that the limiters 30 can swing to the release position P4; at the same time, the transmission shaft 50 will also be pushed by the driving shaft 90 to incline so as to separate from the driving shaft 90, as shown in FIG. 10.

Because of the transmission device 10 of the invention, even without a guider inside the housing of the printer, the transmission shaft 50 still can be engaged with the driving shaft 90 when the toner cartridge is slidably installed in the housing, and the transmission shaft 50 also can incline to separate from the driving shaft 90 when the toner cartridge is taken out of the housing. As a result, the housing of the printer is not necessary to have a guider, so the housing is simple in structure, and costs less money and time to assembly and manufacture.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A transmission device for a photo conductor drum, comprising:
a shell having an opening and a bottom opposite to the opening;
a limiting apparatus having:
a connector mounted in the shell and provided with a first end surface, a second end surface, and a through hole which has a first opening located at the first end surface, and a second opening located at the second end surface and closer to the bottom of the shell than the first opening;
a plurality of limiters mounted to the connector and swingable relative to the connector between a restriction position and a release position; and
a fixed member mounted to the first end surface of the connector to prohibit the limiters from swinging toward the first opening of the through hole from the restriction position;
a joint provided with an opening;
a transmission shaft mounted in the through hole of the connector, axially moveable between a beginning position and a pressed position, and provided with a first end portion which extends out of the first opening of the through hole and the opening of the shell, and a second end portion which is located in the through hole and inserted in the opening of the joint which is closer to the second opening of the through hole than the limiters; wherein when the transmission shaft is rested at the beginning position, the joint pushes the limiters toward the first opening of the through hole such that the limiters are forced to be located at the restriction position to restrict the transmission shaft to be substantially coaxial with the through hole; wherein when the transmission shaft is forced to the pressed position, the limiters are swingable to the release position for allowing the transmission shaft to be inclinable relative to the through hole; and
an elastic member attached between the bottom of the shell and the joint to support the transmission shaft at the beginning position.

2. The transmission device for a photo conductor drum as claimed in claim 1, wherein the connector has a plurality of mounting grooves recessed on the first end surface, and a plurality of slots adjoined with the mounting grooves respectively and opened to the through hole; each said limiter has a mounting portion mounted in one of the mounting grooves, a limiting portion, and a connecting bar connected between the mounting portion and the limiting portion and swingable in one of the slots.

3. The transmission device for a photo conductor drum as claimed in claim 1, wherein the connector has two hooks respectively engaged with two blocks inside the shell.

4. The transmission device for a photo conductor drum as claimed in claim 3, wherein the connector has a plurality of locating slots recessed from the second end surface toward the first end surface and engaged with a plurality of ribs provided inside the shell respectively.

5. The transmission device for a photo conductor drum as claimed in claim 2, wherein the connector has two hook holes, and the fixed member has a ring, which is attached to the first end surface of the connector and covers the mounting grooves, and two hooks which are engaged with the hook holes of the connector respectively.

6. The transmission device for a photo conductor drum as claimed in claim 1, wherein the connector has two retaining slots recessed from the first end surface toward the second end surface, and the second end portion of the transmission shaft is penetrated by a pin which perpendicularly extends relative to an axis of the transmission shaft and has two end portions inserted in the retaining slots respectively.

7. The transmission device for a photo conductor drum as claimed in claim 6, wherein the joint has two apertures perpendicular to the opening of the joint, the transmission shaft has an aperture in the second end portion, and the pin penetrates the apertures of the joint and the aperture of the transmission shaft.

8. The transmission device for a photo conductor drum as claimed in claim 1, wherein the joint has two engagement holes opposite to the opening of the joint, and the engagement holes are engaged respectively with two engagement blocks provided at the second end portion of the transmission shaft.

9. The transmission device for a photo conductor drum as claimed in claim 1, wherein the transmission shaft has an end surface provided at the first end portion, a hollow recessed from the end surface, and two guiding blocks protruding from the end surface, each said guiding block having a guiding surface extending from an outside of the first end portion of the transmission shaft and an engagement concave at one side of the guiding surface.
